(19) United States
(12) Patent Application Publication
(10) Pub. No.: US 2021/0329522 A1
(43) Pub. Date: Oct. 21, 2021

(54) LEARNING-DRIVEN LOW LATENCY HANDOVER

(71) Applicant: HEWLETT PACKARD ENTERPRISE DEVELOPMENT LP, Houston, TX (US)

(72) Inventors: YUANJIE LI, Palo Alto, CA (US); Kyu-Han Kim, Palo Alto, CA (US)

(21) Appl. No.: 16/852,306

(22) Filed: Apr. 17, 2020

(51) Int. Cl. H04W 36/18; H04W 16/22; H04W 36/08; H04W 36/36; H04L 29/08; H04W 36/30; H04W 36/02; G06N 5/04; G06N 20/00

(52) U.S. Cl. CPC H04W 36/18; H04W 16/22; H04W 36/08; H04W 36/36; H04W 88/02; H04W 36/30; H04W 36/023; G06N 5/04; G06N 20/00; H04L 67/34

(57) ABSTRACT

Systems and methods are provided for predicting handover events in wireless communications systems, such as 4G and 5G communications networks. Machine learning is used to refine the predicting of handover events, where per-cell local handover prediction models may be trained by mobile user devices operating in the wireless communications systems. Parameters gleaned from the localized training of the per-cell local handover prediction models may be shared by multiple mobile user devices and aggregated by a global handover prediction model, which in turn may be used to derive refined per-cell local handover prediction models that can be disseminated to the mobile user devices.

### DESCRIPTION OF RELATED ART

Handovers in mobile networks refer to a mobile user device/user equipment, e.g., cell phone, moving from one cellular base station to another cellular base station. During handover, service to the mobile user device can be disrupted due to the delay that results from the mobile user device moving from one base station to another. However, latency-sensitive applications may not tolerate such disruptions.

Machine learning (ML) can refer to a method of data analysis in which the building of an analytical model is automated. ML is commonly considered to be a branch of artificial intelligence (AI), where systems are configured and allowed to learn from gathered data. Such systems can identify patterns and/or make decisions with little to no human intervention.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A illustrates an example of handover between cells in a wireless communications system.

FIG. 1B illustrates example operations effectuating the handover of FIG. 1A.

FIG. 2A illustrates an example distributed machine learning system.

FIG. 2B illustrates an example distributed machine learning architecture for handover prediction in accordance with an embodiment of the disclosed technology.

FIG. 3A illustrates an example handover prediction scenario and operations for effectuating handover prediction in accordance with one embodiment.

FIG. 3B is a schematic representation of global and local models used in handover prediction in accordance with one embodiment.

FIG. 4A illustrates an example per-cell local model training algorithm in accordance with one embodiment.

FIG. 4B illustrates an example global model update algorithm in accordance with one embodiment.

FIG. 5 is an example computing component that may be used to implement various features of handover prediction in accordance with one embodiment of the disclosed technology.

FIG. 6 is an example computing component that may be used to implement various features of embodiments of the present disclosure.

The figures are not exhaustive and do not limit the present disclosure to the precise form disclosed.

### DETAILED DESCRIPTION

Conventional processing of handovers involves a serving cellular base station asking the mobile user device to monitor the signal strength of signals received from cellular base stations (both serving and target). The mobile user device may be configured with certain handover trigger thresholds regarding signal strength. If those handover trigger thresholds are met, the serving cellular base station runs its local handover decision algorithm(s), and can send a handover command to the mobile user device. Upon receipt of the handover command, the mobile user device will disconnect from the serving cellular base station, and connect to another/target cellular base station.

As alluded to above, disruptions in service can occur due to the performance/occurrence of handovers. Although attempts have been made to reduce handover latency, including, e.g., predicting handover occurrence using 4G/5G signaling messages in mobile user device hardware, the information needed to make such handover predictions often require some level of system privilege, and not many mobile user devices have the requisite level of access to obtain this information.

Accordingly, various embodiments are directed to a distributed system for online handover prediction that uses only information that can be obtained from mobile user device APIs, e.g., Android/iOS APIs. Moreover distributed or decentralized machine learning can be leveraged such that an edge or cloud parameter server can obtain per-cell local model parameters for handover predictions from mobile user devices across different geographical areas. The edge/cloud parameter server can aggregate the local model updates, and refine a global handover prediction model. The local model can be trained to learn events that trigger handovers, and handover thresholds by both the edge/cloud server and each mobile user device. The edge/cloud server can, through the global model, map each serving cellular base station to its local model, and as noted above, aggregate local updates by cell identifier, refining each local model.

Handover prediction is performed at the mobile user device, where at runtime, a mobile user device downloads a local model from the edge/cloud, based on its serving cellular base station, predicts a handover, updates its local mode parameters, and sends updates to the edge/cloud. It should be noted that signal measurements are still required, but they can be inferred with runtime signal strengths and handover event information that is readily available from the Android/iOS APIs. In this way, handovers can be predicted more easily, and any resulting latencies can be masked by, e.g., pre-rendering and/or pre-transmitting graphical frames.

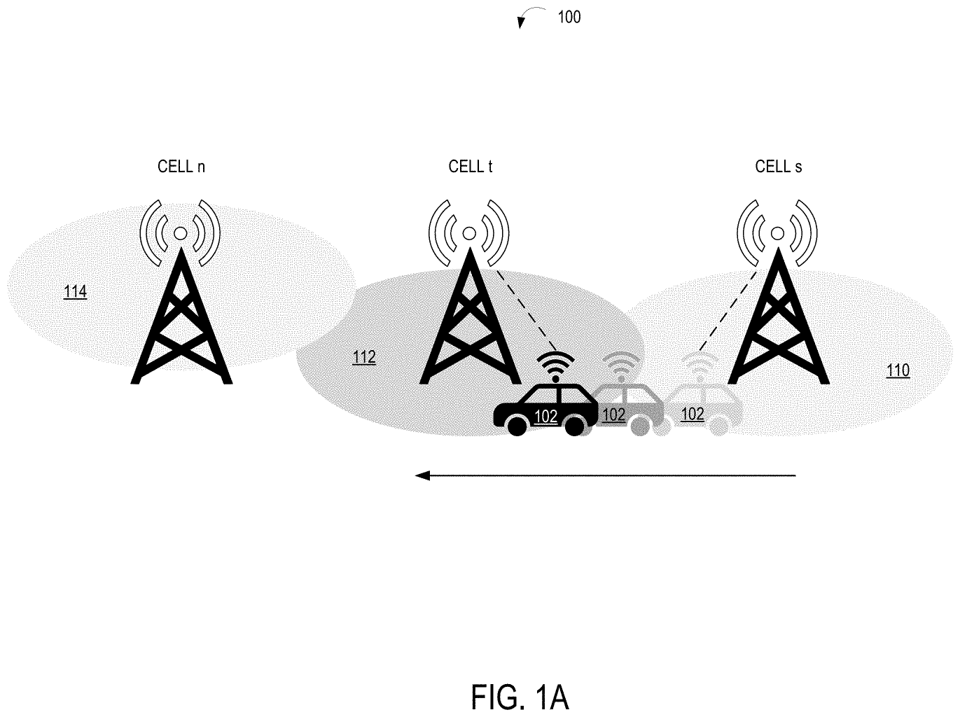

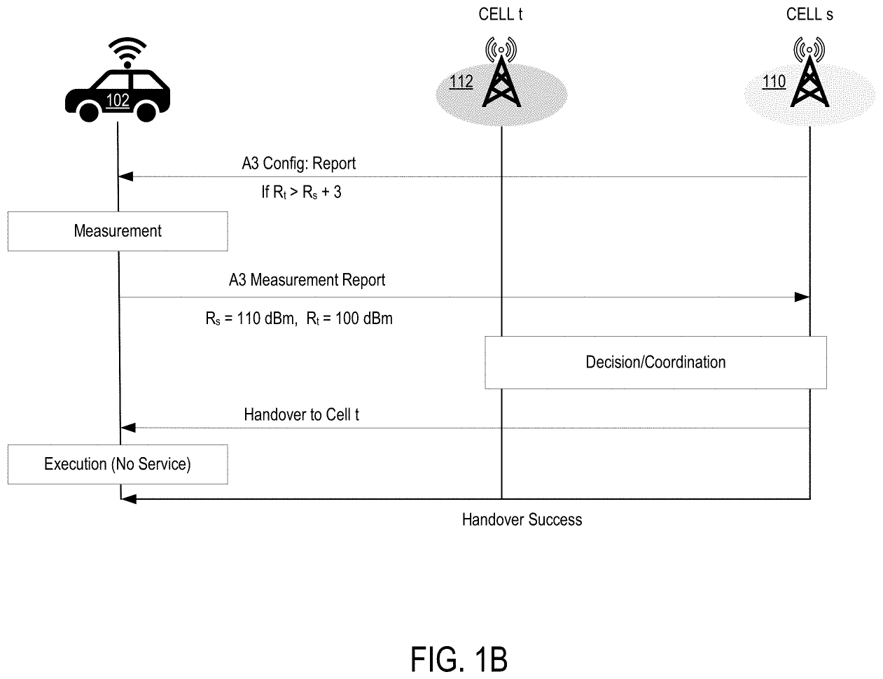

To provide context for various embodiments, the particulars of performing handovers, e.g., in 4G and 5G systems/networks, will first be discussed. FIG. 1A illustrates how 4G and 5G systems can support device mobility. At a high level, communications service(s) such as Internet access, for example, can be provided to mobile devices using multiple radio base stations (cells), each of which covers a geographical area. FIG. 1A illustrates three examples of such cells, e.g., cell s, cell t, and cell n, where each of the cells s, t, and n provides a particular geographical coverage area. In this example, cell s provides wireless communications (e.g., Internet access) within or over coverage area 110A, cell t provides service across coverage area 112, and cell n provides service across coverage area 11. It should be understood that certain geographical areas can also be covered by multiple cells. As illustrated in FIG. 1A, it can be seen that coverages areas 110 and 112 overlap, while coverage areas 112 and 114 overlap. As a device leaves a current serving cell's radio coverage area, Internet access is maintained by migrating a device from the current serving cell to a new target cell.

In the example of FIG. 1A, a vehicle 102 having communication capabilities or a smart phone (not shown) being used in vehicle 102 is shown to be receiving service from cell s (current serving cell) while vehicle 102 is located within coverage area 110. As vehicle 102 moves or travels towards cell t, it can be appreciated that vehicle 102 may continue to receive service from cell s, but as noted above, the coverage area 110 may overlap with coverage area 112 closer to cell t. Upon traversing past this overlap of coverage areas 110 and 112, vehicle 102 may handover to cell t (target serving cell), and begin receiving service from cell t. In reality, handovers can be frequent, e.g., every 70s on average in walking scenarios, every 8.6s on average when traveling by railways, and can be more frequent still with the deployment of 5G dense small cells. It should be understood that 5G dense small cells may provide superior speed/throughput/latency to 4G cells, but the radio waves (mmWave) used in the high-band 5G spectrum for small cells are much more susceptible/sensitive to being blocked by obstacles, e.g., buildings, trees, etc. and thus their coverage areas are smaller. Thus, handovers can be more frequent.

FIG. 1B illustrates certain events/actions that can occur/be performed to effectuate a handover. Following the example of FIG. 1A, vehicle 102 moves from coverage area 110 (served by cell s) to coverage area 112 (served by cell t). Once vehicle 102 connects to its serving cell (cell s), the serving cell s asks vehicle 102 to monitor the serving cell's (cell s's) and the target cell's (cell t's) signal strengths. Serving cell s configures vehicle 102 with “standard” thresholds and triggering event conditions of the signal strengths (discussed in greater detail below), e.g., if a target cell's (cell t's) signal is weaker than that of the serving cell (cell s). Vehicle 102 may perform signal strength measurements, and If any event criteria are satisfied, vehicle 102 reports the signal strength measurement results to serving cell s send a measurement report back to cell s (which at one point may reflect that cell s's signal strength, Rs (e.g., 110 dBm) is less than that of cell t, Rt (e.g., 100 dBm)). Upon receiving the measurements, serving cell s runs its local handover decision algorithms, and may reconfigure vehicle 102 for further measurements (with updated events/thresholds), or send a handover command to vehicle 102. A some point, as vehicle 102 gets closer to cell t, cell t's signal strength will begin to improve and will eventually surpass that of cell s, at which point a decision to handover service for vehicle 102 from serving cell s to target cell t is made. On receiving the handover command, vehicle 102 will disconnect from the serving cell, and connect to target cell t. During that handover execution, there is no service until vehicle 102 completes disconnection from cell s and connection to cell t (for a successful handover).

Handover is not latency-friendly because during handover, as noted above, a device disconnects from the current serving cell, and connects to the target serving cell, during which the device unavoidably cannot send/receive data. Example latency figures, e.g., in the U.S. with 4G Long Term Evolution (LTE) networks can range from milliseconds up to 1.95s. Moreover, handovers can unnecessarily degrade transmission control protocol (TCP) throughput and prolong data transfer. Such delays may not be acceptable for applications like safe autonomous driving applications (which requires ≤10 ms end-to-end latency), mobile virtual/augmented reality applications (≤25 ms latency), and online mobile gaming (≤100 ms latency), to name a few.

It would be advantageous to allow (end-user) devices to predict a handover ahead of its occurrence, and mask any latencies associated with the handover at the application layer. For example, research has shown that if the device can foresee the handover occurrence, virtual reality applications can pre-render and pre-transmit graphical frames to mask the handover latencies, and TCP can avoid unnecessary congestion window degradation and thus drops in throughput.

However, using conventional technologies, device-side handover prediction would be challenging. First, a 4G/5G handover (as illustrated in FIG. 1B) is decided by the serving cell, not the device because generally, end-user/commodity devices do not have any access to network-side operations. While some tools (e.g., MobileInsight) can expose partial handover parameters in the devices, such tools require certain system privileges (“root” in Android and jailbreak in iOS), and thus, are not practical for most users/devices. Moreover, cellular operators/service providers are reluctant to share their internal handover policy with devices.

Additionally, network operators have diverse goals in deciding when a handover should be performed, including retaining good radio coverage, high-speed access, load balancing, carrier aggregation, and/or some combination of those factors/considerations. To accommodate such factors/considerations, handover policies are distributed and configurable by 4G/5G design, where each cell can customize its handover decision algorithm and parameters (e.g., signal strength thresholds, cell priorities, traffic load thresholds, etc.). In reality, the per-cell handover parameters can be very diverse implying that a single global learning model is ineffective for the per-cell handover decision. Instead, the model should be updated after every handover, yet each cell may only have limited dataset, as it is infeasible to aggregate all cells' data for training.

Deep neural networks (DNNs) may appear attractive, but research has shown that during training, DNNs cannot easily handle model updates after every handover. Additionally, a global model is not accurate, while local per-cell models unavoidably use a small dataset for each cell, due to the nature of handovers. In either case, a DNN will face challenges in training accurate models, and may even suffer from long inference latency that will offset the benefits of predicting the handover, thus working against the desired, ultra low-latency 5G mobility.

Therefore, and as described above, various embodiments are directed to a distributed system for online handover prediction that uses only information that can be obtained from mobile user device APIs, e.g., Android/iOS APIs. In particular, handover decisions are treated as a black box, where information for making the decision to handover is obtained from end-user device APIS, e.g., Android/iOS APIs. Instead of training a single global model, a two-tier structure is adopted, and per-cell local models are built for handover predictions. Such models are interpretable, with parameters used as the per-cell configurable thresholds, and events as each cell's handover decision logic. Devices from different geographical areas share their per-cell models via an edge/cloud server. That is, devices download per-cell models, locally update their instance of the per-cell model with their runtime observations, and upload the model parameters back to the edge/cloud server. The edge/cloud server then aggregates the model updates from devices and refines a global model. We devise online training and prediction algorithms with the streamed small per-cell dataset and efficient parameter update methods with marginal communication complexity (thus low mobile data billing). Both our training and prediction algorithms incur negligible latencies compared with the handover disruptions in thus, retaining the benefits of low-latency mobility support.

Distributed ML, as alluded to above, can be leveraged for its ability to train a common model across multiple nodes (global model) using data (or a subset(s) of data) at each node of the network.

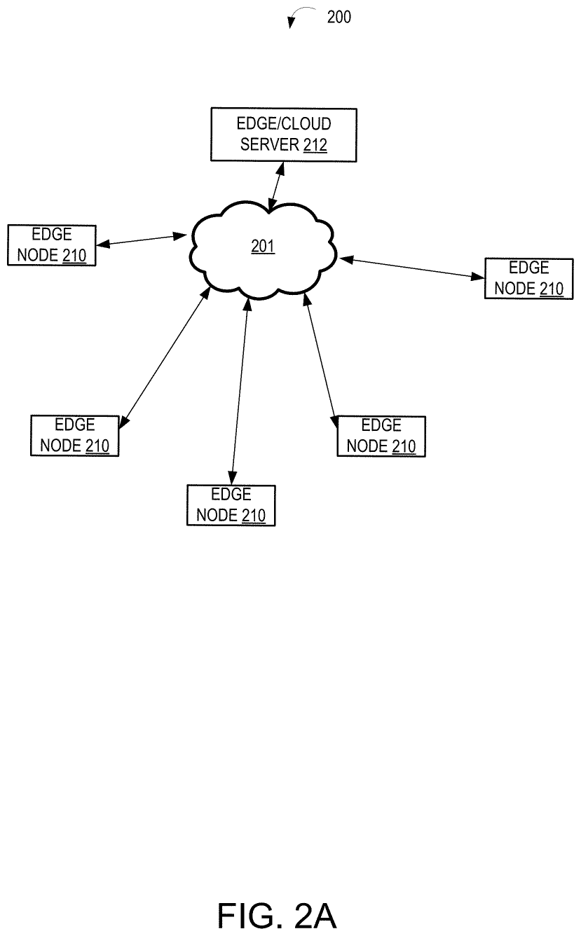

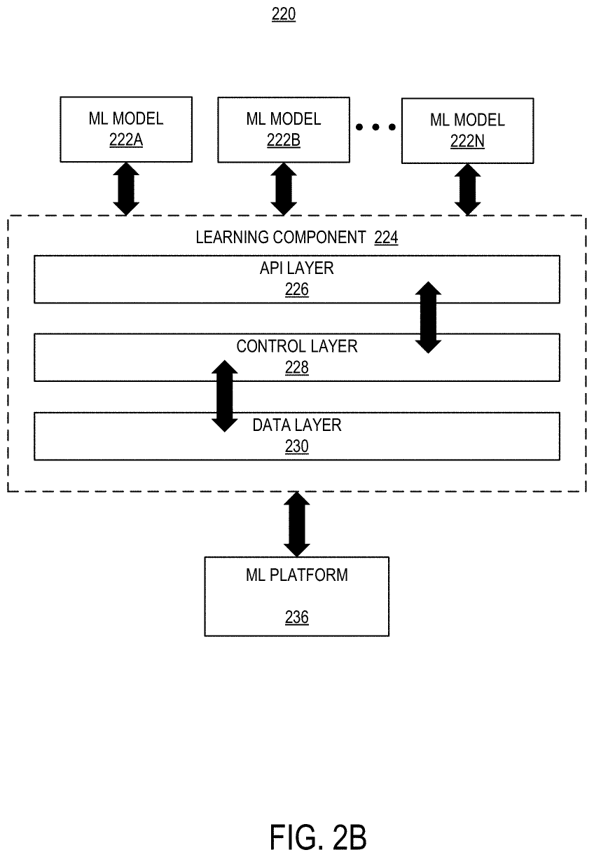

FIG. 2A illustrates an example of a system 200 for distributed learning for predicting handover events in communications networks, such as 5G networks. It should be noted that various embodiments of the technologies disclosed herein are not necessarily limited in application to 5G networks, and can be applied to other networks operating using other communications technologies and/or standards. The examples provided herein are described in the context of 5G networks simply because handovers (as noted above) tend to be more frequent in 5G networks with dense small cells, and 5G networks are to be used to support high-speed, low-latency applications, where the use of distributed ML handover prediction and latency masking would be advantageous. System 200 may include an edge or cloud server 212 and edge nodes 210. Each of edge nodes 210 are representative of end-user devices (mobile phones, computing devices, vehicles, etc.) that may experience handovers between cells of a communications network, such as the aforementioned 5G network. The particular number of, configuration of edge nodes 210, and manner(s) of communications with edge/cloud server 212 may vary. In some embodiments two or more edge nodes 210 may communicate with each other, and/or an edge node 210 may communicate with the edge/cloud server 212 through another edge node 210, e.g., as a relay, such as in vehicle-to-vehicle (V2V) context. As such, the arrangement shown in FIG. 2A is for illustrative purposes only. It should also be understood that system 200 may include other components/elements, such as switch devices, backup systems that provide failover protection for, e.g., edge/cloud server 212, management nodes, etc. (none of which are illustrated), but would be understood as being included if warranted.

Each of edge nodes 210 may each include one or more processors, one or more storage devices, and/or other components (not shown, but would be understood by those having ordinary skill in the art. For example, a vehicle capable of wireless communications, e.g., vehicle 102 of FIG. 1 communicating via cells s, t, and/or n, may have the requisite processor(s), memory, and instructions/applications stored in the memory and executed by the processor(s) to effectuate wireless communications.

Edge nodes 210 and edge/cloud server 212 (which may be a node itself) may be coupled to each other via a network 210, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network (such as the aforementioned 5G network), a Public Switched Telephone Network, and/or other network.

FIG. 2B illustrates an example distributed learning architecture 220 that may be used in accordance with various embodiments. This distributed learning architecture 220 may include local ML models 222A-222N. These local ML models 222A-222N may be maintained and trained at each of edge nodes 210/end-user devices making up a network, such as a 5G network. The distributed learning architecture 220 may also include a learning component 224 which may include an API layer 226, a control layer 228, and a data layer 230. The learning component 224 may operate atop a ML platform 236 (that is distributed amongst edge notes 210/end-user devices), and may be implemented in edge/cloud server 212. It should be noted that edge nodes 210 (where ML models 222A, 222B . . . , 222N are trained) may themselves have all the infrastructure components and control logic used for controlling/managing distributed learning in some embodiments.

As alluded to above, information such as runtime signal strengths and handover events (i.e., a serving cell change in connected mode) can be available from end-user device APIs. Learning component 224 can be implemented as an API library 226 available for such end-user device APIs. These APIs provide an interface that is similar to the training APIs in the native frameworks familiar to data scientists. Calling these APIs automatically inserts the required “hooks” for distributed learning so that edge nodes 210 can seamlessly obtain/transfer parameters at the end of each model training epoch, and subsequently continue the training after resetting the local models to globally merged parameters, or alternatively, downloading updated local models from edge/cloud server 212 after global parameter merging.

Responsibility for keeping system 200 in a globally consistent state lies with the control layer 228, which is implemented using blockchain technology. The control layer 228 ensures that all operations and the corresponding state transitions are performed in an atomic manner. The state can comprise information such as the current epoch, the current members or participants of the distributed learning network, along with their IP addresses and ports, and the URIs for parameter files.

Data layer 230 controls the reliable and secure sharing of model parameters. Like control layer 228, data layer 230 is able to support different file-sharing mechanisms, such as hypertext transfer protocol secure (HTTPS) over transport layer security (TLS), interplanetary file system (IPFS), and so on. Data layer 230 may be controlled through the supported operations invoked by control layer 228, where information about this layer may also be maintained.

For ease of explanation, certain notations/syntax used in various embodiments will be provided below in Table 1, and 4G/5G standard criteria of device-side measurement reports and example value ranges of experimentally-observed configurable parameters are provided below in Table 2.

TABLE 1

| | |
|---|---|
| CID, CIDₜ | Serving cell's/target cell's identifier |
| Rs, Rt | Serving cell's/target cell's signal strength |
| xᵢ = (CIDs, CIDⁱₜ, xⁱₛ, xⁱₜ) | i-th feature (measurement) from Android/iOS |
| | APIs |
| yᵢ ϵ {0, 1} | Label of whether xᵢ triggers the handover |
| Xₛ = {xᵢ, yᵢ}ⁿᵢ₌₁ | Training dataset for a serving cell s |
| A1, A2, . . . A5 | Standard 4G/5G measurement conditions |
| Δ^{U}_{A1}, . . . Δ^{U}_{A5}, | Upper/lower bounds of inferred thresholds |
| Δ^{L}_{A1}, . . . Δ^{L}_{A5} | |
| eₜ ϵ {A1, . . . A5} | Triggering events of handover to CIDₜ |
| ϵ_{A1}, . . . ϵ_{A5} | Prediction errors for A1, . . . , A5 |
| | classifier |

TABLE 2

| | | | Range in dataset |
|---|---|---|---|
| Event | Explanation | Criteria | (RSRP) |
| A1 | Serving cell's signal | Rₛ > Δ_{A1} | Δ_{A1} ϵ > [−140, −62] |
| | getting better | | |
| A2 | Serving cell's signal | Rₛ < Δ_{A2} | Δ_{A2} ϵ > [−140, −43] |
| | getting worse | | |
| A3 | Target cell's signal | Rₜ > Rₛ + Δ_{A3} | Δ_{A3} ϵ > [−15, 15] |
| | weaker than serving | | |
| | cell's signal | | |
| A4 | Target cell's signal | Rₜ > Δ_{A4} | Δ_{A4} ϵ > [−140, −105] |
| | getting better | | |
| A5 | Serving cell's signal | Rₛ < Δ¹_{A5}, | Δ¹_{A5} ϵ > [−139, −43], |
| | weak AND target cell's | Rₜ > Δ²_{A6} | Δ²_{A5} ϵ > [−137, −88] |
| | signal good | | |

To make a handover decision, a serving cell uses signal strength measurements, configurable parameters, and a decision algorithm. Runtime measurements may include the end-user device-perceived signal strength (from measurement reports), and other operator-customized internal metrics (e.g., a serving cell's traffic load and transmission power). Regarding the configurable parameters, signal strength thresholds have been standardized in 4G/5G (Table 2, with notations in Table 1) and used by many if not all commodity/consumer-grade end-user devices (such as cellular/smart phones) and the corresponding cells serving those end-user devices. A cellular operator/provider may also define internal parameters for use by handover decision algorithms (e.g., thresholds for traffic loads, priorities between cells, access control list, to list a few). The handover decision algorithms are customizable, and usually follow well-justified common practices. In particular, most handovers are triggered by the reception of standard measurement events in Table 2, such as an A3 event for handover between cells in the same frequency bands, an A4 event for load balancing, and an A5 event for handover between different bands. A1 and A2 event are typically used for serving cells only and do not generally directly trigger handovers. Accordingly, the following description will focus on A3, A4, and A5 events, although in other scenarios/examples/embodiments A1 and A2 events may be used.

It should be noted that it is possible fora serving cell to trigger a handove rwithout signal measurements (referred to as “blind handover”). However, blind handovers are typically (highly) discouraged and rare in practice. Without an end-user device-perceived signal strength, blind handovers can result in letting the end-user device lose radio coverage to a weak cell, and may cause signaling storms with oscillations.

It should be understood that while a serving cell can evaluate other metrics (e.g., traffic load, access control list, priority, etc.), a serving cell still asks an end-user device to report a target cell's signal strength before making a final handover decision. Otherwise, blind handover may occur, which may force the device to lose the radio coverage and/or trigger signaling storms for cellular (other mobile/wireless service) operators.

As alluded to above, 4G/5G signal strength measurements follow standard messages and configurable events/parameters. It should be noted that rather than testing signal strengths directly, the operational serving cells usually trigger handovers upon receiving the events (Table 2) that quantize the signal strengths with threshold parameters. This offers more robust decisions to wireless dynamics and noises. Indeed, these events/parameters are not accessible for most commodity devices' software (in the hardware modem, root/jailbreak is required). But, such information can be inferred by the device with the runtime signal strengths and handover events (i.e., serving cell change in the connected mode), both of which are available from Android/iOS APIs.

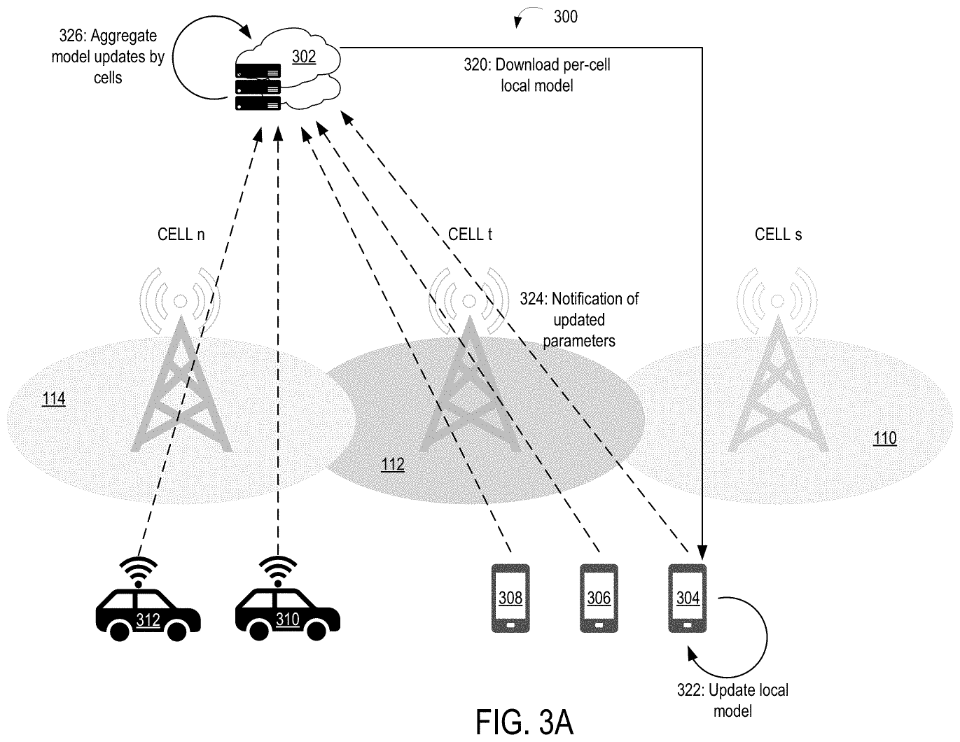

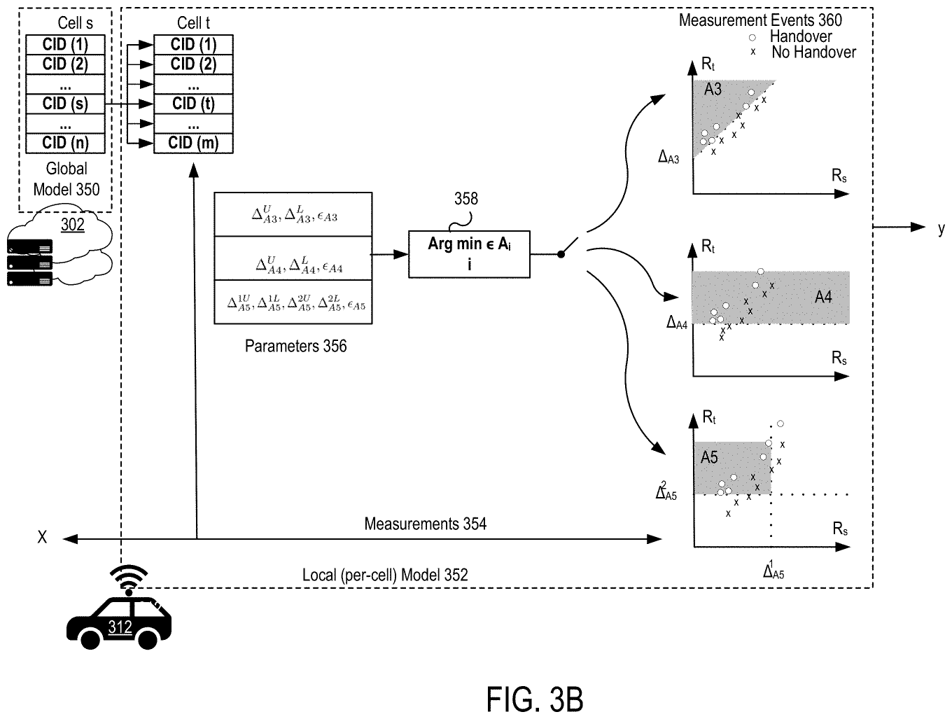

To this end, in accordance with one embodiment, handover prediction can be modeled as a binary classification. Referring back to FIG. 2B, learning component 224 may collect the runtime signal measurements from end-user device APIs, map them into the standard events (based on the inferred parameters), and predict if the current signal measurements will trigger a handover. Since each cell can customize its models, the global handover prediction model can be decoupled from the per-cell local model (as will be discussed in greater detail below, e.g., with respect to FIG. 3B).

Referring now to FIG. 3A, an example scenario involved handover model use in accordance with one embodiment is illustrated. Similar to FIG. 1A, FIG. 3A illustrates a communications network 300, which may be a 5G network. Network 300 may include three cells, cell s, cell t, and cell n providing service within respective coverage areas 110, 112, and 114. End-user devices, such as mobile phones 304, 306, and 308, as well as vehicles 310 and 312 are shown to be within one or more of coverage areas 110, 112, and/or 114, and presumably communicating/receiving service from one of the cells, cell s, cell t, or cell n.

Recalling the distributed learning architecture of FIG. 2A, end-user devices 306-312 may correspond to edge nodes 210, and edge/cloud server 302 may be an embodiment of edge/cloud server 212. At runtime, a mobile device, e.g., end-user device 304 may download a local handover prediction model or simply, local model (or an instance thereof) from edge/cloud server 302 at an operation 320. Based on its current serving cell, e.g., cell s, (and more particularly signal strength measurements, configurable parameters, and the applicable handover decision algorithm used by the provider controlling cell s), end-user device 304 predicts when a handover is to occur, updates the local model parameters at an operation 322, and notifies, by transmitting to the edge/cloud server 302, of its updated parameters at an operation 324. In some embodiments, that can be a batch updating. At an operation 326, edge/cloud server 302 may aggregate the global model with updated parameters gleaned from local models.

As noted already, handover prediction may be based on information that can be obtained/gleaned from end-user device APIs without needing to expose such information from system-privilege level access. From this API-obtained information, each feature can be represented as xi=(CIDₛ, CIDⁱₜ, Rⁱₛ, Rⁱₜ), where CIDₜ and CIDₜ are globally unique identifiers for a serving cell, and a target cell, respectively, and Rₛ and Rₜ can refer to the serving cell's signal strength, and the target cell's signal strengths. It should be noted that In 4G/5G networks, each each cell is uniquely identified by its mobile country/network code (MCC/MNC), tracking area code (TAC), frequency band (EARFCN), and physical cell ID. All are available from end-user device APIs. It should also be noted that an end-user device may measure signal strength as Reference Signal Received Power (RSRP), Reference Signal Received Quality (RSRQ), or Received Signal Strength Indicator (RSSI) based on a serving cell's configuration.

An end-user device may keep collecting the features with new measurements until it hands over to a new (target) cell. Thus, the feature sequence can be denoted as x₁, x₂, . . . , xₙ). After handover, the end-user device can label each xᵢ (i=1, . . . , xₙ) based on the target cell identifier. Each xᵢ can be labeled with yᵢ ∈{0, 1} that indicates whether xᵢ triggers the handover. It should be understood that in accordance with one embodiment, yi is set to equal 1 (yᵢ=1 iff xᵢ is the last one whose CIDₜ is equal to the target cell, and yᵢ=0 otherwise. The intuition is that, in reality, most serving cells' handover decisions are triggered by the latest measurements regarding the same target cell. A new training set Xₛ={(xᵢ, tᵢ)}ⁿᵢ₌₁ can then be obtained for the serving cell CIDₛ.

FIG. 3B illustrates an example handover prediction model used in accordance with various embodiments. As noted above, a two-tier structure is used comprising a local (per-cell) model 352, and a global model 350 to achieve a distributed ML architecture. In general, each node (in this case, an end-user device, possessing local training data (signal strength measurements/handover triggering events) can be used to train a common ML model, and parameters derived from training the common ML model using the local training data can then be aggregated and used to update a global model.

The local per-cell model operates on a per-cell basis, and infers each cell's handover decision logic. A cell's handover decision logic can be assumed to follow the event-driven model, where each candidate target cell CIDₜ is associated with a standard event, eₜ. The serving cell will trigger a handover to CIDₜ if it receives eₜ from an end-user device. Since each geographical area can be covered by multiple cells (e.g., the aforementioned overlapping coverage areas), there can be multiple candidate target cells. To this end, a cell's local model will index its neighboring cells, each of which is associated with its triggering event. To predict the handover with feature xᵢ, will lookup xᵢ.CIDₜ in the index, obtain its events 360 and parameters 356 (signal thresholds), and report yᵢ=1 if xᵢ's signal measurements satisfy the event (otherwise, it will report yᵢ=0).

Global model 350 can be implemented/maintained in the edge/cloud server 302, and can have two functions. First, regarding each end-user device's request, it maps each serving cell to its local model. Second, it aggregates the local updates from different devices by cell ID, and refines each cell's local model. Besides the device-side updates, the edge/cloud server 302 can optionally refine the per-cell model with feedback from 5G infrastructure. It should be understood that both the local model 350 and the global model 352 are interpretable. That is, parameters 356 reflect the signal strength thresholds configured by a serving cell, while the events reflect the serving cell's handover decision logic. This helps end-user devices understand an operator's policies, and debug possible handover failures.

In training the local model 352 for each cell, learning component 224 (FIG. 2B) may simultaneously learn the event eₜ that can trigger a handover to CIDₜ, and eₜ's signal strength thresholds. Both the edge/cloud server 302 and an end-user device can train a local model. Edge/cloud server 302 may initialize and train the local model, and then distribute it to the end-user devices for subsequent training using per-cell specific data/features (measurements 354).

It should be understood that different from existing solutions with end-user device system/root privilege, measurement events cannot be directly observed (again, only end-user device APIs are used). Additionally, each cell's dataset can be small. For example, according to certain research, 90% of cells have ≤36 (87) measurement reports. Such a small dataset is caused by the nature of handover i.e., as an end-user device migrates to another target cell, it can no longer collect signal strength samples from the old serving cell. Solutions like DNN may not be able to train accurate models with such a small dataset. To address these deficiencies, however, various embodiments fit the training dataset with standard events in Table 2 (during which the associated thresholds are also learned), and chooses the event with minimal fitting errors. Given a target CIDₜ, it can be assumed that the serving cell will trigger its handover with a specific event (e.g., A3). According to Table 2, if this assumption is true, all features {(xᵢ, yᵢ)} about CIDₜ should satisfy

$$\begin{matrix}{max}_{\text{?} = 0} \{ R \text{?} - R \text{?} \} \leq {Δ}_{A 3} \leq {min}_{\text{?} = 1} \{ R \text{?} - R \text{?} \} . & ( 1 )\end{matrix} \text{?} \text{indicates text missing or illegible when filed}$$

That is, A3's threshold can be bounded by the measurements with/without handover. Similarly, assuming A4 or A5 is the event to trigger a handover, the following should be true

$${max}_{\text{?} = 0} R \text{?} \leq {Δ}_{A 4} \leq {min}_{\text{?} = 1} {R}_{t} , {max}_{\text{?} = 1} R \text{?} \leq {Δ}_{A 5}^{1} \leq {min}_{\text{?} = 0} {R}_{\text{?}} , {max}_{\text{?} = 0} R \text{?} \leq {Δ}_{A 5}^{2} \leq {min}_{\text{?} = 1} {R}_{t} , \\ \text{?} \text{indicates text missing or illegible when filed} \qquad ( 2 )$$

If, however, A3 (A4/A5) is not the event that triggers handover, A3 (A4/A5) based prediction will cause errors (outliers) over the training set (visualized in FIG. 3B). But, since the measurement events are triggered deterministically, the correct event should incur the smallest error. By fitting the data for each event and tracking its errors, the correct event and its parameter bounds can be concurrently learned. This can achieve high accuracy even with the small per-cell dataset.

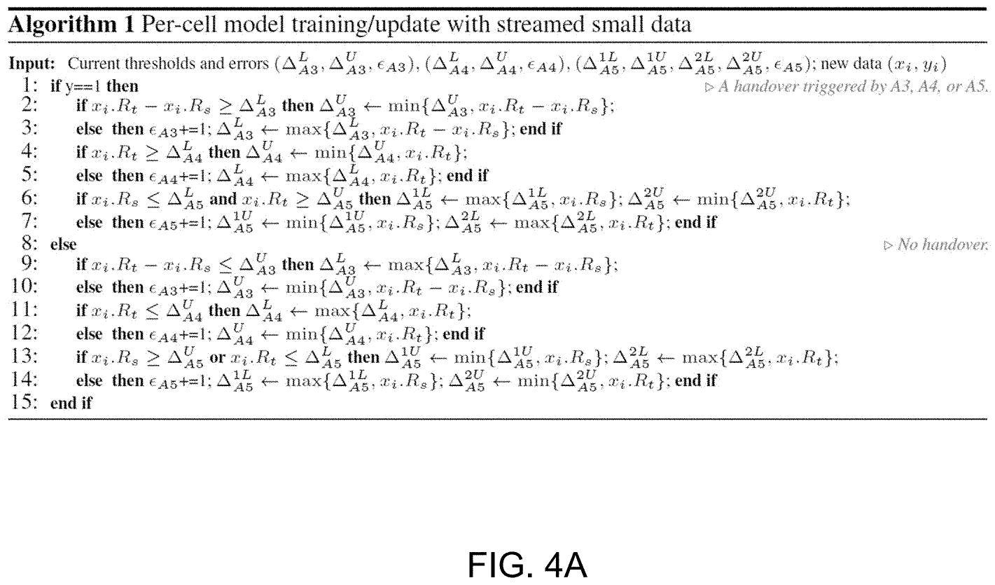

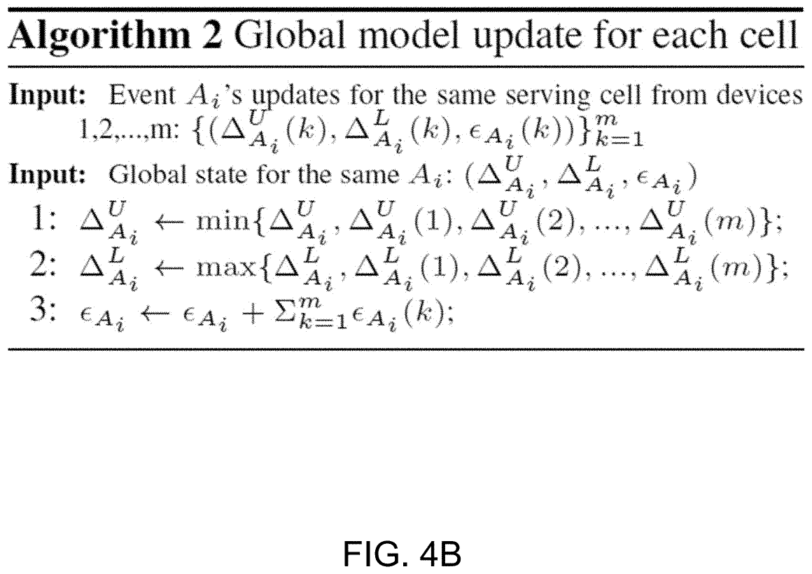

Algorithm 1 illustrated in FIG. 4A reflects an example local training algorithm based on the above approach. Algorithm 1 may be a streaming algorithm without the need for storing historical data. For each candidate target cell, a local model maintains per-event threshold upper/lower bound (Δ^{U}_{Ai}, Δ^{L}_{Ai}) (initialized as −∞, ∞) and error ∈_{Ai} (initialized as 0). Once new data is available, algorithm 1 updates the threshold bounds and errors based on equation (1) and (2) above. At runtime, an end-user device may predict a handover with the event with the smallest error ∈_{A1}, and its parameter as (Δ^{U}_{Ai}+Δ^{L}_{Ai})/2.

Edge/cloud server 302 can refine operation of various embodiments with marginal use of communication bandwidth (thus mobile data billing) using two primitives: model update from the end-user devices, and model refinement with infrastructure feedback. Similar to the generic distributed learning, various embodiments can aggregate end-user devices' local updates and refine the local per-cell model.

Yet, high accuracy may still be maintained with asynchronous communication and local parameter compression, which does not always hold for generic asynchronous Stochastic Gradient Descent. Such a benefit comes from the fact that equations (1)-(2) and Algorithm 1 only need min/max for the threshold bounds (Δ^{U}_{Ai}, Δ^{L}_{Ai}), and monotonic counting operations for the errors error ∈_{Ai}. Algorithm 2 illustrated in FIG. 4B shows how edge/cloud server 302 updates the global model 350. An end-user device reports its local update of (Δ^{U}_{Ai}, Δ^{L}_{Ai}, ∈_{Ai}), to the edge/cloud server 302. It can either update to edge/cloud immediately, or report in batch after sufficient updates (thus saving mobile data billing). The edge/cloud server 302 aggregates these updates by serving/target cell pair, and updates its global parameters/errors with min/max/counting operations. These operations can also be easily parallelized via MapReduce-like computing platforms.

Regarding model refinement with infrastructure feedback, the recentl promulgated 5G standards allow controlled information sharing between network infrastructure and edge servers (via ETSI radio APIs). In particular, the 5G infrastructure can expose the events in Table 2 to the edge. Various embodiments are able to optionally leverage this functionality to further refine the global model 350. If the edge can obtain the event information from 5G infrastructure (e.g., A3 for handover), it can reduce the scope of events to be tested in Algorithm 1 (e.g., there would be no need to fit data for A4/A5). This improves model accuracy and reduces the model size.

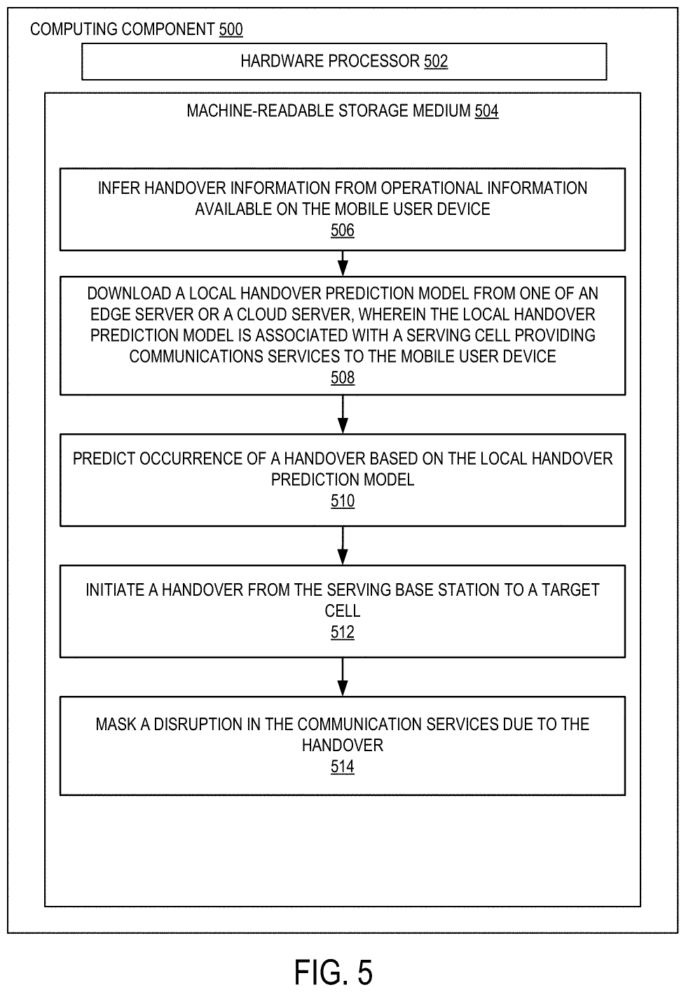

FIG. 5 is an example computing component 500 that may be used to implement various features of an elected merge leader in accordance with one embodiment of the disclosed technology. Computing component 500 may be, for example, a server computer, a controller, or any other similar computing component capable of processing data. In the example implementation of FIG. 5, the computing component 500 includes a hardware processor 502, and machine-readable storage medium 504. In some embodiments, computing component 500 may be an embodiment of processor of an edge node 210, end-user device, e.g., 304, 312, and edge/cloud server 302, etc.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-518, to control processes or operations for merging local parameters to effectuate swarm learning in a blockchain context using homomorphic encryption. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-514.

Hardware processor 502 may execute instruction 506 to infer handover information from operational information available on a mobile user device, e.g., end-user device, such as a mobile phone, vehicle, laptop computer, tablet computer, etc. As described previously, various embodiments need not exploit system-level privileges, but rather can glean the requisite information from an end-user device API such as signal strength measurements and serving cell/target cell ID information.

Hardware processor 502 may execute instruction 508 to download a local handover prediction model from one of an edge server or a cloud server, wherein the local handover prediction model is associated with a serving cell providing communications services to the mobile user device. As described above, various embodiments leverage a two-tier, distributed ML architecture, where end-user devices train local handover prediction model instances based on per-cell handover events/information. Updates based on training the local handover prediction models from each of the end-user devices may be transmitted to the edge or cloud server, where the edge or cloud server updates a global handover prediction model. Upon refining the global handover prediction model, refined versions mapped to the cells of the mobile communications network can be retrieved by the end-user devices for use/additional training.

Hardware processor 502 may execute instruction 510 to predict occurrence of a handover based on the local handover prediction model, and may execute instruction 512 to initiate a handover from the serving base station to a target cell. Hardware processor 502 may then execute instruction 514 to mask a disruption in the communication services due to the handover. By more accurately predicting handovers, masking the disruption can be effectuated at the appropriate times to hide any latency issues arising from handovers, especially in the context of 5G communications, where handovers can be more frequent to due the nature of the radio signals (mmWave) used, e.g., in 5G dense small cells.

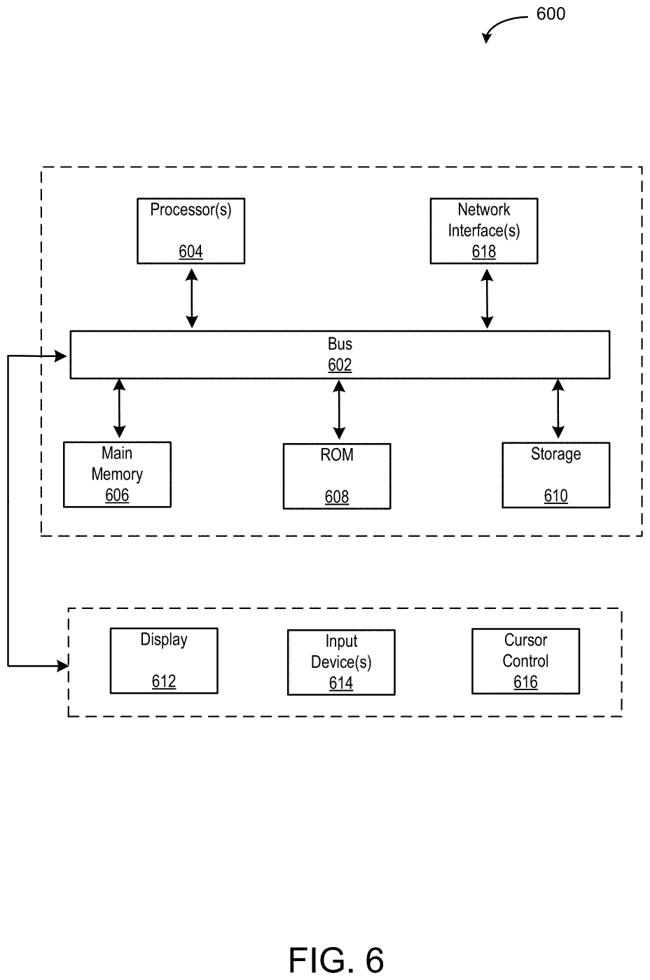

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions. Also coupled to bus 602 are a display 612 for displaying various information, data, media, etc., input device 614 for allowing a user of computer system 600 to control, manipulate, and/or interact with computer system 600. One manner of interaction may be through a cursor control 616, such as a computer mouse or similar control/navigation mechanism.

In general, the word “engine,” “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

1. A mobile user device, comprising:
a processor; and
a memory unit operatively connected to the processor and including computer code that when executed, causes the processor to:
infer at least one of A1 and A2-related handover event information from operational information available on the mobile user device, the operational information being obtained from an operating system application programming interface (API) running on the mobile user device;
download a local handover prediction model from one of an edge server or a cloud server, wherein the local handover prediction model is a per-cell handover prediction model associated only with a serving cell providing communications services to the mobile user device derived from a global handover prediction model;
predict occurrence of a handover based on the local handover prediction model and the inferred A1 and A2-related handover event information;
initiate a handover from the serving base station to a target cell; and
mask a disruption in the communication services due to the handover.

2. The mobile user device of claim 1, wherein the operational information comprises runtime signal strength.

3. (canceled)

4. The mobile user device of claim 1, wherein the memory unit includes computer code that when executed further causes the processor to train the local handover prediction model using the inferred A1 and A2-related handover event information.

5. The mobile user device of claim 4, wherein the local handover prediction model comprises an algorithm that learns events triggering the handover and additional handovers to the target cell and other target cells, and signal strength thresholds associated with the events.

6. The mobile user device of claim 5, wherein the algorithm comprises a streaming algorithm maintaining upper and lower bounds of the signal strength thresholds on a per-event basis, and errors.

7. The mobile user device of claim 5, wherein the events comprise 4G and 5G standardized device-side criteria regarding signal strength measurements.

8. The mobile user device of claim 7, wherein the memory unit includes computer code that when executed further causes the processor to map the operational information to the events based on the inferred handover information.

9. The mobile user device of claim 4, wherein the memory unit includes computer code that when executed further causes the processor to transmit updates from the trained local handover prediction model to the edge server or the cloud server, the updates from the trained local handover prediction model being aggregated into the global handover prediction model.

10. The mobile user device of claim 9, wherein the memory unit includes computer code that when executed further causes the processor to receive updated local handover prediction models obtained through refinement by the global handover prediction model.

11. The mobile user device of claim 10, wherein the updated local handover prediction models are further refined based on information sharing exchange between the edge server or the cloud server and infrastructure of a mobile communications network within which the mobile user device operates, the mobile communications network including the serving cell and the target cell.

12. The mobile user device of claim 1, wherein the computer code that when executed causes the processor to mask the disruption in the communication services comprises computer code that when executed further causes the processor to pre-render and pre-transmit graphical frames associated with an existing communications session involving the mobile user device.

13. A mobile user device, comprising:
a processor; and
a memory unit operatively connected to the processor and including computer code that when executed, causes the processor to:
download a per-cell local handover prediction model;
update the per-cell local handover prediction model by training the per-cell local handover prediction model based on inferred A1 and A2-related handover event information based on measured runtime signal strength observed by the mobile user device, the runtime signal being obtained from an operating system application programming interface (API) running on the mobile user device;
transmit updated handover parameters based on the training of the per-cell local handover prediction model for aggregation as part of a global handover prediction model, the global handover prediction model being used to subsequently derive a refined per-cell local handover prediction model; and
download the refined per-cell local handover prediction model for predicting handovers.

14. The mobile user device of claim 13, wherein the memory unit includes computer code that when executed, further causes the processor to map versions of the global handover prediction model to cells of a mobile communications network in which the mobile user device is operative, and wherein one of the mapped versions of the global handover prediction model comprises the refined per-cell local handover prediction model.

15. (canceled)

16. (canceled)

17. The mobile user device of claim 13, wherein the memory unit includes computer code that when executed further causes the processor to train the per-cell local handover prediction model using the inferred handover information.

18. The mobile user device of claim 17, wherein the local handover prediction model comprises an algorithm that learns events triggering the handover and additional handovers to the target cell and other target cells, and signal strength thresholds associated with the events.

19. The mobile user device of claim 13, wherein the memory unit includes computer code that when executed further causes the processor to mask a disruption in communications between the mobile user device and another device.

20. The mobile user device of claim 19, wherein the computer code that when executed causes the processor to mask the disruption comprises computer code that when executed further causes the processor to pre-render and pre-transmit graphical frames associated with an existing communications session involving the mobile user device.

21. The mobile user device of claim 1, wherein the computer code that when executed causes the processor to initiate a handover from the serving base station to a target cell, further causes the processor to initiate handover based upon receipt of one or more events that quantize signal strengths with threshold parameters instead of directly testing signal strength.

22. The mobile user device of claim 13, wherein the memory unit includes computer code that when executed further causes the processor to initiate a handover from the serving base station to a target cell, further causes the processor to initiate handover based upon receipt of one or more events that quantize signal strengths with threshold parameters, the one or more events being specified in the refined per-cell local handover prediction model.
